(19) United States
(12) Patent Application Publication
(10) Pub. No.: US 2024/0131485 A1
(43) Pub. Date: Apr. 25, 2024

(54) CONVERSION OF SOLID WASTE INTO A BLEND HAVING A TARGET COMPOSITION

(71) Applicant: Smart Feed Tech, Inc. dba Bright Feeds, Berlin, CT (US)

(72) Inventors: Jonathan Fife, New York, NY (US); Glenn R. Gaudette, Holden, MA (US); Jamal Yagoobi, Hopkinton, MA (US); Aidan Yagoobi, Hopkinton, MA (US); Timothy Rassias, Holden, MA (US); Alexander Nobel, Brooklyn, NY (US); Daniel Adam, East Canaan, CT (US)

(21) Appl. No.: 18/490,852

(22) Filed: Oct. 19, 2023

Related U.S. Application Data
(60) Provisional application No. 63/418,292, filed on Oct. 21, 2022.

(51) Int. Cl. B01F 35/22; A23L 35/00; B01F 33/84

(52) U.S. Cl. CPC B01F 35/2209; A23L 35/00; B01F 33/846; B01F 35/2206; B01F 2101/06

(57) ABSTRACT

A method includes causing, by at least one processing device, organic material from at least one hopper of a set of hoppers to be provided to a mixer to create a blend, wherein each hopper of the set of hoppers is to store a respective composition of organic material, obtaining, by the at least one processing device from a sensor, sensor data indicative of an actual composition of the blend, determining, by the at least one processing device based on the sensor data, whether the actual composition of the blend satisfies a threshold condition with respect to a target composition of the blend, and in response to determining that the actual composition of the blend satisfies the threshold condition, causing, by the at least one processing device, the blend to be provided to a drying system for drying.

### CROSS-REFERENCE TO RELATED APPLICATION(S)

The present application claims the benefit of U.S. Provisional Application 63/418,292, filed on Oct. 21, 2022, the entire contents of which are incorporated by reference herein.

### TECHNICAL FIELD

The present disclosure is generally related to food manufacturing and processing, and more particularly, to the conversion of solid waste into a blend having a target composition.

### BACKGROUND

Solid waste can include organic material and/or inorganic material. One example of solid waste is food waste. Food waste refers to the disposal of edible food including organic material that is still safe and suitable for consumption (e.g., human and/or animal consumption). Additionally, some food waste can include inorganic material, such as plastic, cardboard, etc. (e.g., food packaging material). Food waste can occur at various stages or levels of the food supply chain. Examples of stages of the food supply chain include the harvesting stage, the processing stage, the distribution stage, and the consumption stage (e.g., consumer and food service). For example, food waste can occur at the harvesting stage when crops remain unharvested, rejected for non-safety reasons (e.g., cosmetic reasons), or are destroyed due to damage (e.g., pests or weather). As another example, food waste can occur at the processing stage by discarding imperfect and/or surplus food products. As yet another example, food waste can occur during the distribution stage when retailers discard edible food products that are near their expiration date and/or non-safety reasons (e.g., cosmetic reasons). As yet another example, food waste can occur at the consumption stage when consumers discard edible food products (e.g., leftovers) or inedible (e.g., spoiled) food products. As yet another example, food waste can occur at the consumption stage in the food service industry when a server of food (e.g., restaurant) discards leftover meals or over-prepares food intended to be served to customers.

Food waste is a global issue that has negative social, environmental, and economic impacts. For example, food waste can contribute to unnecessary resource depletion. Typical means of food waste disposal, such as landfill dumping or incineration, can be economically expensive and can negatively impact the environment by contributing to pollution. For example, such means of food waste disposal can contribute to greenhouse gas (e.g., methane) emissions.

### BRIEF DESCRIPTION OF THE DRAWINGS

The present disclosure is illustrated by way of example, and not by way of limitation, and can be more fully understood with reference to the following detailed description when considered in connection with the figures in which:

FIG. 1 is a block diagram of a system for converting solid waste into a blend having a target composition, in accordance with some implementations.

FIGS. 2A-2C are flowcharts of example methods for converting solid waste into a blend having a target composition, in accordance with some implementations.

FIG. 3 is a block diagram of an illustrative computing device operating in accordance with the examples of the disclosure.

### DETAILED DESCRIPTION

Aspects of the present disclosure are directed to the conversion of solid waste into a blend having a target composition. In some implementations, solid waste is food waste, and a blend is a food blend. A food blend refers to a combination, blend and/or mixture of food waste that is suitable for consumption by at least one target consumer. For example, a target consumer can be an animal (e.g., dog food blend, cat food blend, bird food blend, or other animal food blend). As another example, a target consumer can be a human.

Some solid waste (e.g., food waste) can be generated by commercial businesses, such as restaurants and solid waste processors. Such sources of solid waste can constitute diverse food waste streams. Some challenges in converting solid waste into a food blend are a result of the diversity of solid waste streams. For example, a blend may need to have a target composition and/or consistency, depending on the target consumer of the food blend (e.g., animal or human) One example of a composition is a macronutrient composition. Examples of macronutrients include protein, fat and carbohydrates. Therefore, it can be very difficult to convert food waste from diverse solid waste sources into a blend that achieves a target composition and/or consistency for a target consumer. Accordingly, a small portion of solid waste supplied by diverse food waste streams may end up being converted into a blend, with the majority of such food waste being disposed of using a typical means of disposal (e.g., landfill dumping and/or incineration).

Aspects of the present disclosure address these and other drawbacks by enabling the conversion of solid waste into a blend having a target composition. Solid waste can include organic material and/or inorganic material. In some implementations, the solid waste includes food waste. For example, food waste can include human food waste. The target composition can be selected to be suitable for one or more target consumers. In some implementations, a target consumer is an animal. For example, the blend can be a dog food blend, a cat food blend, a bird food blend, etc. In some implementations, a target consumer is a human.

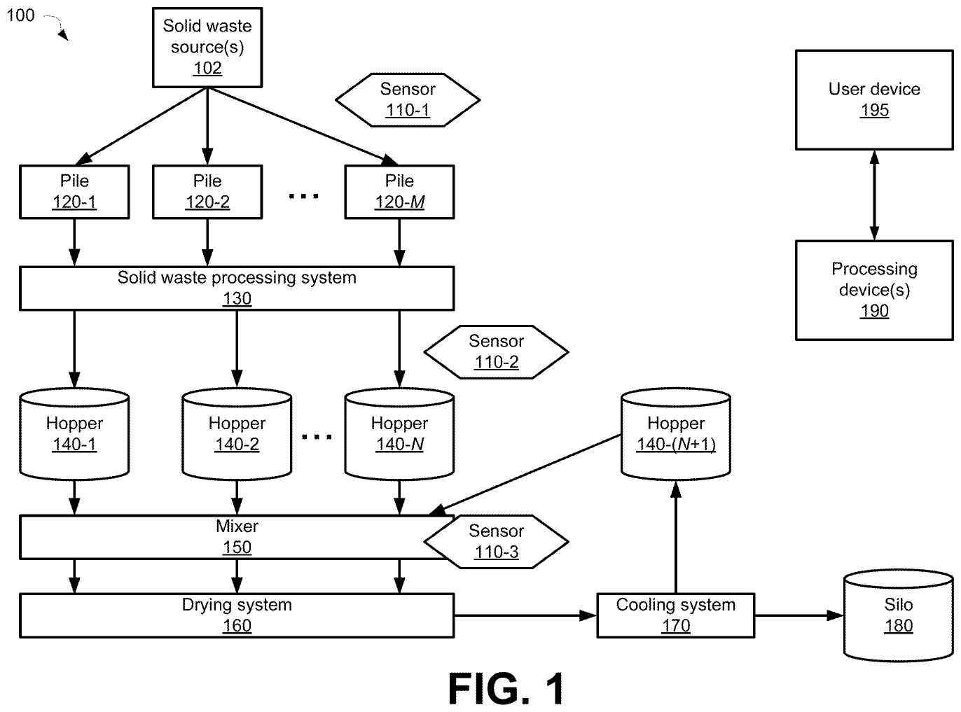

A solid waste conversion system can include various components that can be used to convert solid waste into a blend having a target composition suitable for one or more target consumers. More specifically, the solid waste conversion system can include at least one processing device (e.g., controller) that can control the operations of the solid waste conversion system to create a blend having a target composition that is optimized for resource consumption based on a set of constraints. For example, the solid waste conversion system can receive a collection of solid waste from multiple, diverse solid waste sources (e.g., streams), place solid waste from the collection of solid waste into one or more piles, process the solid waste from one or more of the piles (including removing any inorganic material) to obtain a batch of organic material, store the batch of organic material in at least one hopper of a plurality of hoppers, and create the blend from one or more batches of organic material retrieved from one or more hoppers of the plurality of hoppers. The at least one processing device can use input data, which can include sensor data obtained from multiple sensors strategically placed within the system, to control where solid waste received from one or more solid waste sources can be optimally stored and/or selected to create a blend having a target composition. In some implementations, the at least one processing device determines, using a model from input data based on a set of constraints, a target composition for a blend that is optimized for resource consumption in accordance with the set of constraints. Further details regarding the components and operation of the solid waste conversion system will be described below with reference to FIGS. 1-3.

Implementations described herein can provide for various advantages. For example, implementations described herein can reduce the negative externalities that can be caused by typical food waste disposal means, such as reducing pollution and reducing economic waste.

FIG. 1 is a diagram of a system 100 for converting solid waste into a blend having a target composition, in accordance with some implementations. As shown, system 100 can include one or more solid waste sources 102, a plurality of sensors including sensors 110-1 through 110-3, a plurality of piles 120-1 through 120-M, solid waste processing system 130, a plurality of hoppers 140-1 through 140-(N+1), mixer 150, drying system 160, cooling system 170, silo 180, and at least one processing device 190. Hopper 140-(N+1) can be referred to as a supplemental hopper. In some implementations, M is equal to N. The number of solid waste sources, piles, sensors, solid waste processing systems, hoppers, mixers, drying systems, cooling systems and silos shown should not be considered limiting. At least one processing device 190 can include at least one controller of a control system for controlling operations of system 100.

In some implementations, the plurality of sensors includes at least one near-infrared (NIR) sensor. More specifically, an emitter can emit electromagnetic radiation (e.g., light) having at least one NIR wavelength toward an object. In some implementations, an NIR wavelength ranges between about 750 nanometers (nm) to about 2500 nm. For example, electromagnetic radiation can include broad-spectrum light within the NIR spectrum. One example of an emitter is a spontaneous emission device (e.g., light-emitting diode (LED)). Another example of an emitter is a stimulated emission device (e.g., laser). The object can absorb at least some of electromagnetic radiation (i.e., absorbed electromagnetic radiation) and/or reflect at least some of the electromagnetic radiation (i.e., reflected electromagnetic radiation). An NIR sensor can receive the reflected electromagnetic radiation, and measure data related to the reflected electromagnetic radiation to perform NIR spectroscopy. NIR spectroscopy can be used to identify various properties of the object. One property of the object is the actual composition of the object. For example, as will be described in further detail below, the actual composition can include an actual nutrient composition. The actual nutrient composition can include a combination of variables such as macronutrient composition (e.g., protein, fat, carbohydrates), ash levels, moisture, etc. Illustratively, there can be a direct relationship between the amount of absorbed electromagnetic radiation and the moisture content of the object (i.e., the greater the amount of absorbed electromagnetic radiation, the higher the moisture content of the object).

The operations of system 100 can be divided into a solid waste intake stage, a solid waste processing stage, and a blend creation and storage stage. During the solid waste intake stage, a collection of solid waste is received from one or more solid waste sources 102 (e.g., streams). In some implementations, one or more solid waste sources 102 includes a plurality of solid waste sources. Each solid waste source can be a distinct (e.g., independent) solid waste source. The collection of solid waste can include organic material. In some cases, the collection of solid waste can further include a combination of inorganic material and organic material. Examples of inorganic material include cardboard, plastic, etc. In some implementations, the collection of solid waste includes a collection of food waste. For example, inorganic material that can be included in food waste can include packaging material used to package food (e.g., cardboard and/or plastic). In some implementations, the collection of food waste includes human food waste. In some implementations, the collection of food waste includes bakery food waste. In some implementations, the collection of food waste includes non-bakery food waste. In some implementations, one or more solid waste sources 102 include one or more vendors. For example, a vendor can be a commercial business, such as a restaurant, a food waste processor, etc.

During the solid waste intake stage, after receiving the collection of solid waste from one or more solid waste sources 102, sensor 110-1 can generate (e.g., measure) first sensor data indicative of a composition of the collection of solid waste. For example, sensor 110-1 can instantaneously measure the first sensor data as the collection of solid waste is received. In some implementations, the composition includes a nutritional composition of the collection of solid waste. The nutritional composition of the collection of solid waste can include a combination of variables such as protein, moisture, fiber, fat, ash levels, etc. For example, the nutritional composition of the collection of solid waste can be defined by a respective percentage of each variable within the collection of solid waste.

During the solid waste intake stage, at least one processing device 190 can select, based on the first sensor data, at least one pile of plurality of piles 120-1 through 120-M for storing at solid waste from the collection of solid waste, and cause the solid waste to be stored in the pile. That is, at least one processing device 190 can cause solid waste as it is received to be sorted into one or more respective piles of the plurality of piles 120-1 through 120-M. In some implementations, the sorting is continuous. Each pile of the plurality of piles 120-1 through 120-M can define a respective composition for assigning solid waste, and each pile of plurality of piles 120-1 through 120-M can store at least a portion of solid waste determined to have a similar composition. For example, at least one processing device 190 can select a pile from plurality of piles 120-1 through 120-M to assign at least a portion of the solid waste by identifying the pile of plurality of piles 120-1 through 120-M having an assigned composition that is substantially similar to the composition defined by the first sensor data.

The selection of the pile by at least one processing device 190 can be further based on expected future solid waste that will arrive the rest of the day. The selection of the pile by at least one processing device 190 can be further based on solid waste that is expected to arrive for the remainder of the day. For example, several vendors may have dropped off solid waste throughout the day, each of which would be placed in a designated pile, with many others expected to come in whose typical nutritional information will be stored based on past experience.

As will be described in further detail below, during the solid waste processing stage, the pile into which the solid waste is sorted can be used to determine when that solid waste will be processed during the solid waste processing stage, including which hopper of plurality of hoppers 140-1 through 140-N that the solid waste will be stored in. In some implementations, each pile of plurality of piles 120-1 through 120-M corresponds to a respective hopper of plurality of hoppers 140-N.

During the solid waste processing stage, at least one processing device 190 can cause a batch of solid waste to be sent to solid waste processing system 130 for processing. For example, at least one processing device 190 can receive an instruction to initiate the solid waste processing stage, and can cause the batch of solid waste to be created in response to receiving the instruction. The batch of solid waste can be created using solid waste from at least one pile of plurality of piles 120-1 through 120-M. For example, causing the batch of solid waste to be created can include selecting at least one pile of plurality of piles 120-1 through 120-M from which to create the batch of solid waste, and causing solid waste from the at least one pile of plurality 120-1 through 120-M to be transported from the at least one pile to solid waste processing system 130.

During the solid waste processing stage, solid waste processing system 130 can process the batch of solid waste to obtain a batch of organic material by removing (e.g., filtering out) any inorganic material that may be present in the batch of solid waste (e.g., plastic and/or cardboard). For example, at least one processing device 190 can cause solid waste processing system 130 to process the batch of solid waste to obtain the batch of organic material. In some implementations, solid waste processing system 130 includes a filtration system. For example, solid waste processing system 130 can include a depackaging system.

At least one processing device 190 can cause a tool (e.g., auger) to move the batch of organic material to a conveyor belt to be sent to at least one hopper of plurality of hoppers 140-1 through 140-N. Determining when the batch of solid waste is transported from the at least one pile of plurality of piles 120-1 through 120-M to solid waste processing system 130 can be important given potentially limited hopper storage space. For example, if all high protein material is processed in the morning, that would leave only low protein material to be processed later in the day, and a consistent blend throughout the day would not be possible. Therefore, at least one processing device 190 can control when solid waste material stored in each pile of plurality of piles 120-1 through 120-M should be processed, which can be based at least in part on the composition of the solid waste assigned to each respective pile.

Sensor 110-2, which is adjacent to solid waste processing system 130 (e.g., above the conveyor belt), can generate (e.g., measure) second sensor data indicative of the composition of the batch of organic material. For example, sensor 110-2 can be placed at a location immediately after the batch of organic material discharges solid waste processing system 130, in order to generate the second sensor data (e.g., instantaneously) as the material passes below it on the conveyor belt. In some implementations, the composition of the batch of organic material includes a nutritional composition of the batch of organic material. The nutritional composition of the batch of organic material can include a combination of variables such as protein, moisture, fiber, fat, ash (levels), etc. For example, the nutritional composition of the batch of organic material can be defined by a respective percentage of each variable within the solid waste. Given the potential for inorganic material to be mixed with organic material within the solid waste stored in a pile (e.g., food may be in packaging) and limited ability to get a perfectly accurate measurement of the first sensor data via sensor 110-1, the second sensor data can be used to make real-time adjustments after processing performed by solid waste processing system 130.

At least one processing device 190 can then select, based on the second sensor data, a hopper of plurality of hoppers 140-1 through 140-N for storing the batch of organic material. Each hopper of plurality of hoppers 140-1 through 140-N can store a respective type of batch of organic material determined from the composition of the batch of organic material. For example, at least one processing device 190 can cause a conveyor belt to transport the batch of organic material from solid waste processing system 130 to at least one hopper of plurality of hoppers 140-1 through 140-N.

Each hopper of plurality of hoppers 140-1 through 140-N can be associated with an expected composition of organic material based on what organic material is designated to go to each hopper. Each pile plurality of piles 120-1 through 120-M can be associated with at least one hopper of plurality of hoppers 140-1 through 140-N, such that solid waste from a pile can be converted into a batch of organic material designated for at least one associated hopper. Each hopper of plurality of hoppers 140-1 through 140-N can hold a maximum amount of organic material. In some implementations, the maximum amount of organic material ranges from about 1 ton to about 10 tons. In some implementations, the maximum amount of organic material is about 3 tons. A weight measuring device (e.g., load cell) can be used to measure the exact weight of each hopper.

At least one processing device 190 can determine when to cause solid waste from at least one pile of plurality of piles 120-1 through 120-M to be transported to solid waste processing system 130 for processing based on hopper weight, and can cause a batch of organic material created by solid waste processing system 130 to be loaded from solid waste processing system 130 into at least one hopper of plurality of hoppers 140-1 through 140-N. For example, at least one processing device 190 can determine whether a weight of a hopper is less than or equal to a threshold hopper weight and, in response to determining that the weight of the hopper is less than or equal to the threshold hopper weight, can cause solid waste from at least one pile of plurality of piles 120-1 through 120-M to be transported to solid waste processing system 130 for processing.

At least one processing device 190 can cause a set of data related to the batch of organic material to be stored. For example, the set of data can include at least one of the second sensor data and an identifier of the at least one hopper of plurality of hoppers 140-1 through 140-N to which the batch of organic material has been stored in.

In some implementations, the set of data is stored using a data historian. A data historian is a specialized software system or application used in industrial automation and process control environments to collect, store, retrieve, and analyze historical data from various sources within a facility or system. The data historian can continuously collect data from various sensors, instruments, and control systems within system 100. The data historian can store this data in a suitable data format for retrieval and analysis. The data historian can use data compression to store large amounts of data. In some implementations, the data historian retrieves data from a programmable controller that controls equipment of system 100 in order to retrieve and then subsequently store, in the data historian, which hopper(s) of plurality of hoppers 140-1 through 140-N that the batch of organic material gets stored in.

The set of data can be used to update, for each hopper of plurality of hoppers 140-1 through 140-N, a set of hopper data associated with the hopper. For example, the hopper data for a hopper can include at least one average composition of the organic material within the hopper. In some implementations, the at least one average composition is an average nutritional composition of the organic material within the hopper. The average nutritional composition of the organic material within the hopper can include a combination of variables such as protein, moisture, fiber, fat, ash, etc. For example, the nutritional composition of the organic material within the hopper can be defined by a respective average percentage of each variable within the solid waste. At least one processing device 190 can use a set of inputs to determine the actual composition of organic material stored in each hopper. For example, the set of inputs can include the weight of the organic material in each hopper, assumed flow rates, and nutritional and operational data.

During the blend creation and storage stage, organic material stored in at least one hopper of plurality of hoppers 140-1 through 140-N is used to create a blend having a target composition. The target composition can be selected for a target consumer (e.g., animal or human). In some implementations, the target composition includes a target nutritional composition. The target nutritional composition can include a target combination of variables such as protein, moisture, fiber, fat, ash, etc. For example, the target nutritional composition can be defined by a respective target percentage of each variable. For example, at least one processing device 190 can receive an instruction to create a blend in accordance with a target composition. In response to receiving the instruction to create the blend, at least one processing device 190 can cause the blend to be created.

To cause the blend to be created, at least one processing device 190 can cause organic material from at least one hopper of plurality of hoppers 140-1 through 140-N to be transported to mixer 150. For example, at least one processing device 190 can determine, based on the set of hopper data of each hopper of plurality of hoppers 140-1 through 140-N (e.g., nutritional composition of organic material stored in each hopper of plurality of hoppers 140-1 through 140-N), an amount of organic material to retrieve from the at least one hopper of plurality of hoppers 140-1 through 140-N. In some implementations, the blend is a mixture of organic material obtained from multiple hoppers of plurality of hoppers 140-1 through 140-N. The organic material mixture can be defined by a ratio of organic material to be pulled from multiple hoppers of plurality of hoppers 140-1 through 140-N. In some implementation, the creation of the blend is further optimized (e.g., refined) based on a set of auxiliary data. For example, the set of auxiliary data can include data indicative of externalities such as energy consumption, market data (e.g., market rate for various blends), etc. Moreover, hopper weight data can be used to retrieve an optimal amount of organic material from the at least one hopper of plurality of hoppers 140-1 through 140-N.

Sensor 110-3, which is adjacent to mixer 150 (e.g., above the mixer), can generate (e.g., measure) third sensor data indicative of an actual composition of the blend. In some implementations, the actual composition of the blend includes an actual nutritional composition of the blend. The actual nutritional composition of the blend can include a combination of variables such as protein, moisture, fiber, fat, ash levels, etc. For example, the actual nutritional composition of the blend can be defined by a respective percentage of each variable within the solid waste. At least one processing device 190 can determine, based on the third sensor data, whether the actual composition of the blend satisfies a threshold condition defined by the target composition. For example, the at least one processing device can determine whether the actual composition of the blend is within an acceptable range of the target composition.

If the actual composition of the blend does not satisfy the threshold condition (e.g., it is not within an acceptable range of the target composition), then at least one processing device 190 can cause an adjustment to the composition of the blend. For example, at least one processing device 190 can adjust the composition of the organic material mixture (e.g., ratios among organic material obtained from hoppers of plurality of hoppers 140-1 through 140-N). Accordingly, the third sensor data can be used to make real-time adjustments to the organic material being pulled from each hopper if the actual composition of the blend is not sufficiently close to the target composition of the blend. As an illustrative example, the actual composition of the blend can indicate that the blend does not contain the expected amount of protein defined by the target composition. Since data indicative of the actual composition of the organic material stored in each hopper is being maintained (e.g., via the data historian), at least one processing device 190 can determine an additional amount of organic material that may be needed to be pulled from a higher protein hopper so that the actual protein composition of the blend is within an acceptable range the target protein composition of the blend. If the actual composition of the blend satisfies the threshold condition (e.g., it is within an acceptable range of the target composition), this means that the blend has a suitable composition for consumption by the at least one target consumer.

It may be the case that the moisture content of the blend is too high to enable the blend to be safely stored for a sufficient amount of time. To address this, during the blend creation and storage stage, the blend can be provided to drying system 160 for drying. For example, the at least one processing device can cause the blend to be transported from mixer 150 to drying system 160 (e.g., via an auger). In some implementations, drying system 160 is a heat-based drying system including a heat-based dryer. For example, drying system 160 can include a natural gas based dryer (e.g., a flash dryer). In some implementations, drying system 160 operates continuously. The composition of the blend can be optimized (e.g., adjusted) to optimize drying conditions, and the drying performed by drying system 160 can be controlled to optimize energy consumption. Accordingly, the blend can be created before drying.

During the blend creation and storage stage, drying system 160 can dry the blend to remove enough moisture such that a moisture condition of the blend satisfies a threshold moisture condition suitable for storing the blend for a sufficiently long period of time. For example, the threshold moisture condition can be a moisture of less than or equal to a threshold amount of moisture. The drying process can end upon determining that the moisture condition of the blend satisfies the threshold moisture condition. In some implementations, the threshold amount of moisture ranges from about 0% moisture to about 20% moisture. In some implementations, the threshold amount of moisture ranges from about 5% moisture to about 15% moisture. Illustratively, the threshold amount of moisture can be about 12% moisture.

After the blend is sufficiently dried (e.g., the blend has a moisture condition that satisfies the threshold moisture condition), during the blend creation and storage stage, the blend can be provided to cooling system 170 for cooling prior to storage. For example, at least one processing device 190 can cause the blend to be transported from drying system 160 to cooling system 170. In some implementations, the blend is transported from drying system 160 to cooling system 170 via a conveyor system. For example, the conveyor system can be a pneumatic conveyor system.

After cooling the blend, during the blend creation and storage stage, the blend can be stored. At least a portion of the blend can be stored in silo 180. In some implementations, all of the blend is stored in silo 180. For example, at least one processing device 190 can cause the blend to be transported from cooling system 170 to silo 180. From silo 180, the blend can be loaded into containers for transport and delivery. In some implementations, system 100 includes multiple silos, and at least one processing device 190 can determine that it is optimal to have multiple blends, where each blend can be sent to a respective silo for storage.

In some implementations, at least a portion of the blend is stored in supplemental hopper 140-(N+1). For example, at least one processing device 190 can cause at least a portion of the blend to be sent from cooling system 170 to supplemental hopper 140-(N+1). The organic material stored in supplemental hopper 140-(N+1) can be used to lower the moisture content of future blends being created in mixer 150, if necessary.

In some implementations, one or more supplements can be used to aid in the creation of the blend. For example, one or more supplements can be used in order to meet target consumer or operational requirements if the actual composition is straying from the target composition. One example of a supplement are wheat middlings (“wheat midds”). Wheat midds are a byproduct of the wheat milling process and can include particles (e.g., fine particles) of wheat bran, wheat shorts, wheat germ, and wheat flour. Wheat midds can have had most of the flour removed, making them higher in fiber and protein, and lower in fat content and energy, than wheat grain. Accordingly, wheat midds can be used as supplement if fat content is too high to achieve the target composition (e.g., added into mixer 150). Supplements can be added up until they reach a target amount within the total blend (e.g., 25%). The target amount within the total blend can be adjustable. Thus, supplements can increase throughput rate and reduce energy consumption.

At least one processing device 190 control operations during the solid waste intake stage, the solid waste processing stage and/or the blend creation and storage stage based on a set of constraints. The set of constraints can define parameters that can be used to create a blend having a target composition that is optimized for resource consumption. In some implementations, at least one processing device 190 uses at least one model to determine, from input data include a set of constraints, a target composition for a blend that is optimized for resource consumption. More specifically, the model can be trained to achieve a blend having a target composition with optimized resource consumption, based on a set of constraints (e.g., energy, throughput, nutrients). As more data is acquired, the model will be better informed, resulting in improvements to outputs of the model.

In some implementations, the model is a mathematical programming model. A mathematical programming model is a model in which an objective function is maximized or minimized for an input based on a set of constraints. For example, the model can be a linear programming model, in which the objective function is a linear function, the input can be represented by a vector or matrix, and the set of constraints can be a set of linear constraints. The set of linear constraints can define a solution space (i.e., feasible region), which can be geometrically represented as a convex polyhedron. It may be the case that the solution space includes the null set (i.e., the linear programming is infeasible). Linear programming can be performed using any suitable method. In some implementations, linear programming is performed using a basis exchange method (e.g., simplex method or criss-cross method). In some implementations, linear programming is performed using an interior point method (e.g., ellipsoid method or projective method).

In some implementations, optimizing resource consumption includes optimizing energy consumption. For example, at least one processing device 190 can optimize drying of the blend using drying system 160 to minimize energy consumption while achieving the target composition (e.g., target moisture). Illustratively, certain nutritional compositions may go through drying system 160 better than others (e.g., achieve a higher throughput per hour). Also, organic material that has too high of a fat content can pose a safety hazard due to increased risk of fire.

In some implementations, at least one processing device 190 optimizes resource consumption based on an expected schedule of inputs from solid waste source(s) 102. This can include at least one expected pile of plurality of piles 120-1 through 120-M that solid waste should be stored in, at least one expected hopper of plurality of hoppers 140-1 through 140-N that a batch of organic material should be stored in, and an expected ratio of organic material from one or more hoppers of plurality of hoppers 140-1 through 140-N that is transported into mixer 150.

For example, assume that solid waste sources (e.g., vendors) include solid waste sources A-G, and a delivery schedule includes Monday (M), Tuesday (T), Wednesday (W) and Thursday (Th). The follow table shows an example of an expected schedule of input solid waste that can be received from solid waste sources A-G throughout the week:

TABLE 1

| | M | T | W | Th |
|---|---|---|---|---|
| A | 20 tons | 10 tons | 25 tons | 10 tons |
| B | 20 tons | — | — | — |
| C | 10 tons | — | — | — |
| D | — | 15 tons | 15 tons | 15 tons |
| E | — | 10 tons | 10 tons | 10 tons |
| F | — | 40 tons | 40 tons | 40 tons |
| G | — | 25 tons | 25 tons | 25 tons |

Further assume that a set of constraints includes the blend should have less than or equal to about 40% moisture and that variability of protein levels between consecutive days should be less than or equal to about 5%. Illustratively, on Monday, at least one processing device 190 can generate, using the model, a set of candidate outputs for Monday. The set of candidate outputs can correspond to the creation of piles of solid waste received from the solid waste sources on Monday (e.g., 20 tons from A, 20 tons from B, and 10 tons from C). The number of candidate outputs can be in the order of thousands. After generating the set of candidate outputs, at least one processing device 190 can determine, for each candidate output of the set of candidate outputs, whether the candidate output satisfies the set of constraints (e.g., the candidate output corresponds to ≤40% moisture and/or ≤5% variability of protein levels between days). In response to determining that a candidate output satisfies the set of constraints, the candidate output can remain. Otherwise, the candidate output can be eliminated from the set of candidate outputs. The process generates a set of filtered outputs, where each output of the set of filtered outputs satisfies the set of constraints. The at least one processing device can then perform a similar process for the remaining days of the week (e.g., Tuesday-Thursday) to generate respective sets of candidate outputs, and generate respective sets of filtered outputs by eliminating candidate outputs that fail to satisfy the set of constraints.

In some implementations, input data is received in the form of a tabular data structure (e.g., spreadsheet). For example, solid waste source(s) can be assigned respective source identifiers (IDs) based on composition of their solid waste (e.g., nutritional content or values). An illustrative example of a tabular data structure, including solid waste sources (e.g., vendors) A-G and compositions including protein, fiber, fat and moisture, is provided in the following table:

TABLE 2

| | A | B | C | D | E | F | G |
|---|---|---|---|---|---|---|---|
| Tons | 5.5 | 8 | 10.5 | 7 | 7.5 | 5 | 2.5 |
| Protein | 22.8 | 9 | 18 | 7.2 | 26.4 | 7 | 8 |
| Fiber | 0.75 | 2 | 6.3 | 6.5 | 6.5 | 3 | 3 |
| Fat | 6.9 | 7 | 11 | 18.1 | 11.6 | 5 | 6 |
| Moisture | 29.5 | 20 | 22 | 38.5 | 41.4 | 22 | 21.5 |

After the inputs are taken, at least one processing device 190 can assign solid waste from a particular solid waste source to a particular pile. The assignment can be made based on the set of constraints for the blend (e.g., the blend cannot be more than 8% fat, protein has to be greater than 12%, moisture less than 30%). To ensure the optimal pile assignment, at least one processing device 190 can analyze thousands of combinations of pile assignments, and eliminate those combinations of pile assignments that fail to meet the set of constraints. At least one processing device 190 can further analyze the remaining combinations of pile assignments to identify an optimal pile assignment with an optimal composition for the blend to be created. Illustratively, if the optimal composition is the composition with highest protein value, then the optimal pile assignment can be identified as the pile assignment that yields the composition with the highest protein value. As described above, supplements (e.g., wheat midds) can be optionally added to a pile to modify composition (e.g., higher protein percentage, lower fat percentage).

If solid waste from a solid waste source has the potential of disrupting the nutritional balance (e.g., the solid waste from a solid waste source has too much moisture, protein, etc.), then the solid waste received from that solid waste source can be addressed in various ways. For example, a pile can either be completely taken out of all the solid waste source, or solid waste can be introduced into the pile in small increments. To illustrate, if solid waste provided by a solid waste source has an overly high level of moisture t, then solid waste from that solid waste source can be introduced into a pile in, e.g., 1-2 ton increments rather than all at once.

To ensure a more consistent blend output, the model can designate a default blend for a day of the week that controls the blends for the rest of the week. Illustratively, if the default blend is the blend produced on Monday, then the blend produced on Monday is what the rest of the week is based upon. For example, if the blend produced on Monday has a protein percentage of 12.5% and at least one processing device 190 determines that Tuesday's blend provides two candidate outputs of 23% protein and 12.3% protein, then the 12.3% protein candidate output can be selected to improve day-to-day consistency.

An illustrative example of a tabular data structure (e.g., spreadsheet) illustrating blends for respective days of the week (Monday-Friday) is provided as follows:

TABLE 3

| Day of the | Guaranteed | Guaranteed | Guaranteed |
|---|---|---|---|
| week | protein | fiber | fat |
| Monday | 17.83 | 4.14 | 7.03 |
| Tuesday | 14.3 | 5.96 | 9.04 |
| Wednesday | 17.74 | 3.89 | 7.49 |
| Thursday | 14.62 | 5.42 | 6.47 |
| Friday | 14.8 | 4 | 6.91 |

In Table 3, guaranteed protein refers to the lowest protein percentage that was produced on a given day. Guaranteed fiber refers to the lowest fiber percentage that was produced on a given day. Guaranteed fat refers to the lowest fat percentage that was produced on a given day. A variance can be determined with respect to each of the guaranteed protein, guaranteed fiber and the guaranteed fat. Each variance defines a respective incremental amount from the mean. For example, the protein variance can be about 1.77, the fat variance can be about 0.99, and the fiber variance can be about 0.94. If the mean protein for the week is 15.86, then the amount of protein can be varied by about 1.77 each day.

The sensor data generated by sensors 110-1 through 110-3 can be used to modify operation of system 100. For example, as described above, sensor 110-1 can generate first sensor data indicative of an actual composition of solid waste that is received from solid waste source(s) 102. As solid waste is received and measured by sensor 110-1, changes can be made to at least one of: the at least one actual pile of plurality of piles 120-1 through 120-M that the material is stored in, the at least one actual hopper of plurality of hoppers 140-1 through 140-N that the corresponding batch of organic material is stored in, or the actual ratio of organic material retrieved from each hopper of plurality of hoppers 140-1 through 140-(N+1) into mixer 150 may change. Additionally, the expected piles/hoppers/mixer ratios for solid waste expected to arrive later in the day may change. Thus, at least one processing device 190 can update input data for the model by using the actual data that comes as it may differ from the expected data. Moreover, at least one processing device 190 can update input data for the model periodically as new data is received.

As another example, as described above, sensor 110-2 can generate second sensor data indicative of an actual composition of the batch of organic material that exits solid waste processing system 130, and each hopper of plurality of hoppers 140-1 through 140-N can be associated with an expected composition of organic material based on what organic material is designated to go to at least one hopper of plurality of hoppers 140-1 through 140-N. If the actual composition of the batch of organic material output by solid waste processing system 130 differs from the expected composition of the batch of organic material, then at least one processing device 190 can cause a change to the destination of the batch of organic material (e.g., the batch of organic may be diverted to a different hopper).

As yet another example, as described above, sensor 110-3 can generate third sensor data indicative of the actual composition of the blend in mixer 150. If at least one processing device 190 determines that the actual composition of the blend differs from the expected composition of the blend (i.e., the target composition), at least one processing device 190 can cause a modification to the blend. For example, at least one processing device 190 can cause additional material to be pulled from one or more hoppers of plurality of hoppers 140-1 through 140-(N+1) to meet the target composition (e.g., perform real-time adjustments to the ratios of material pulled from the one or more hoppers). Such a modification can cause changes downstream as changes are made to the ratio of material taken from each hopper of plurality of hoppers 140-1 through 140-(N+1) in accordance with the model.

A least one processing device 190 can further cause a graphical user interface (GUI) to be displayed on user device 195. The GUI can provide a visualization of data (e.g., current states of the piles, hoppers, and other components of system 100). The GUI can enable a system administrator or system operator to make modifications to the operations of system 100, if necessary, to create a blend having a target composition.

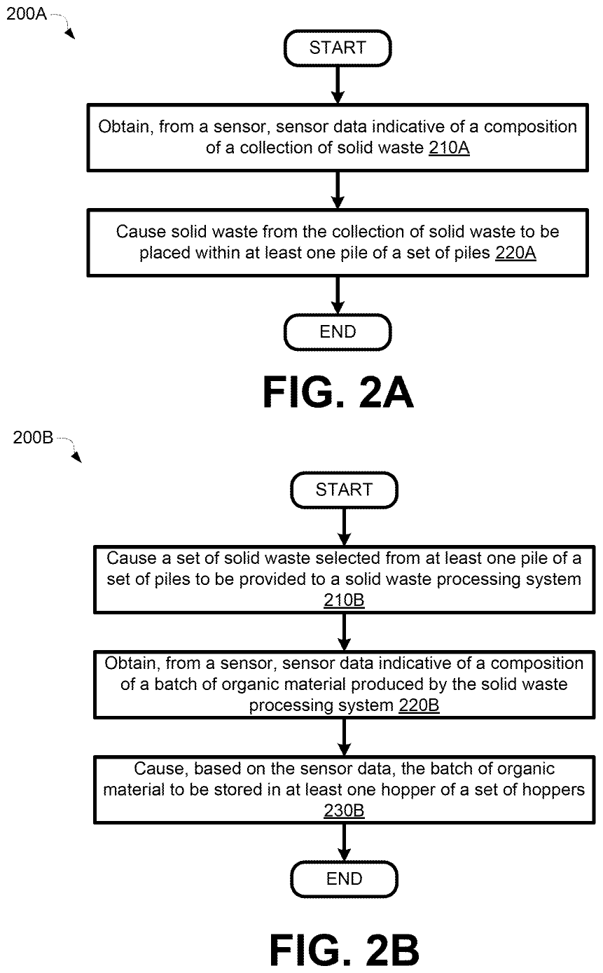

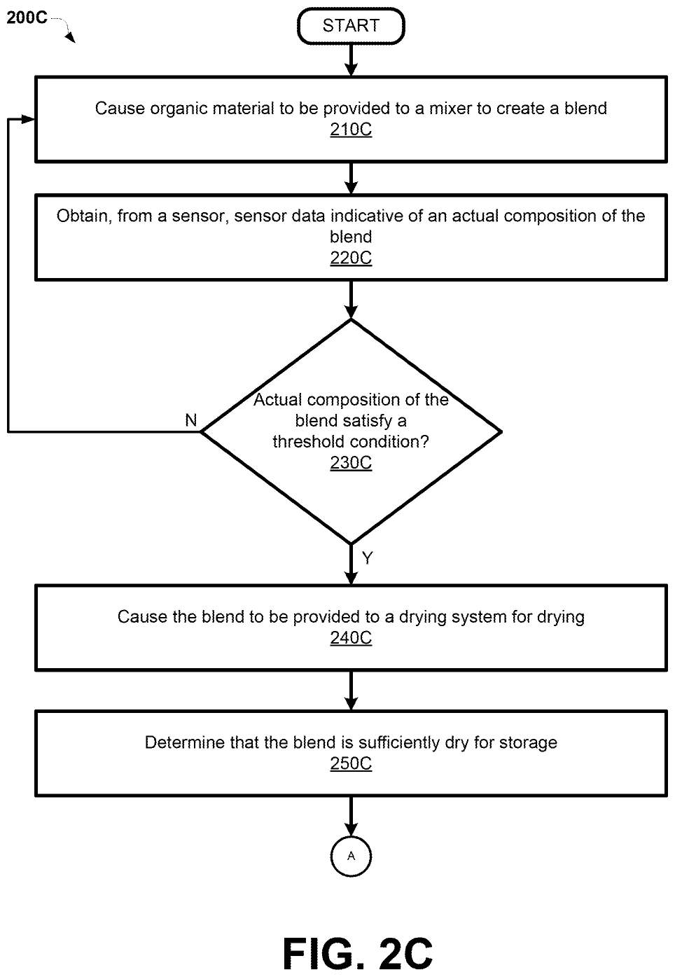

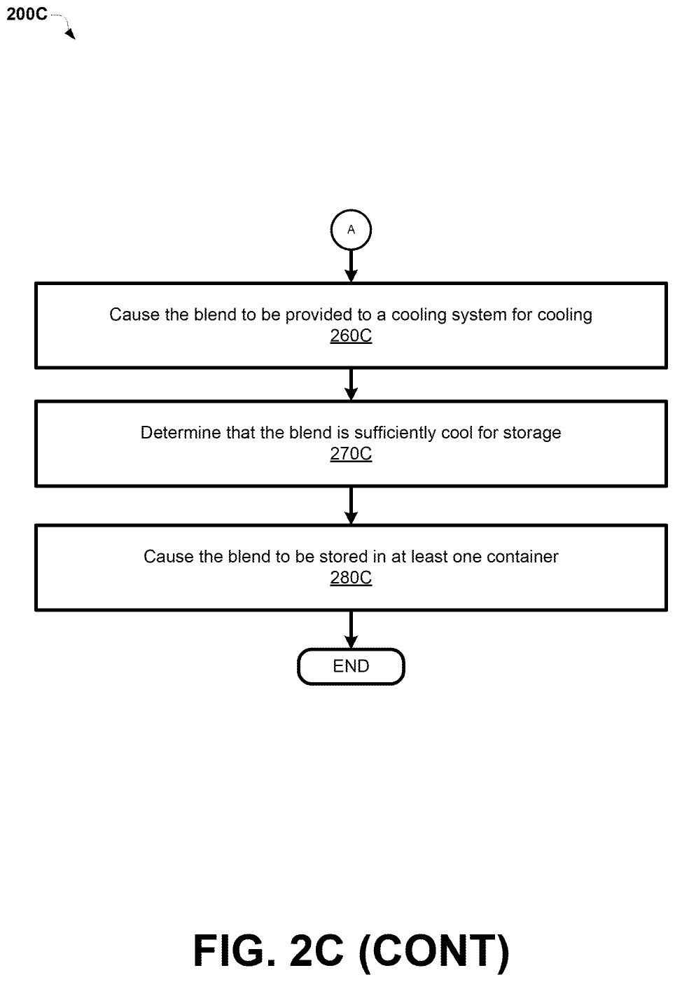

FIGS. 2A-2C are flowcharts of example methods 200A-200C for converting solid waste into a blend having a target composition, in accordance with some implementations. in accordance with some implementations. The target composition can be selected for a target consumer (e.g., animal or human). In some implementations, the target composition includes a target nutritional composition. The target nutritional composition can include a target combination of variables such as protein, moisture, fiber, fat, ash levels, etc. For example, the target nutritional composition can be defined by a respective target percentage of each variable.

For example, methods 200A-200C may be performed by at least one processing device (e.g., at least one processing device 190 of FIG. 1). For example, the at least one processing device can receive an instruction to create a blend in accordance with a target composition. In response to receiving the instruction to create the blend, at least one processing device can cause the blend to be created. Methods 200A-200C may be performed by one or more processing devices that may comprise hardware (e.g., circuitry, dedicated logic, programmable logic, microcode, etc.), executable code (such as is run on a general-purpose computer system or a dedicated machine), or a combination of both. For example, the one or more processing devices can perform individual functions, routines, subroutines, or operations to implement methods 200A-200C. At least some operations of the method can be performed by implementing a model (e.g., linear programming model), as described above with reference to FIG. 1.

FIG. 2A is a flowchart of an example method 200A for implementing a solid waste receiving stage of a process for converting solid waste into a blend having a target composition, in accordance with some implementations.

At operation 210A, processing logic obtains, from a sensor, sensor data indicative of a composition of a collection of solid waste. For example, the sensor can be located adjacent to an entry point for the collection of solid waste. The collection of solid waste can include raw solid waste obtained from one or more solid waste sources. In some implementations, the collection of solid waste is obtained from a plurality of solid waste sources.

At operation 220A, processing logic causes solid waste from the collection of solid waste to be placed within at least one pile of a set of piles. Each pile of the set of piles defines a respective composition for assigning solid waste. Further details regarding operations 210A-220A are described above with reference to FIG. 1

FIG. 2B is a flowchart of an example method 200B for implementing a solid waste processing stage of a process for converting solid waste into a blend having a target composition, in accordance with some implementations. In some implementations, method 200B can be performed after the completion of method 200A of FIG. 2A.

At operation 210B, processing logic causes a set of solid waste selected from at least one pile of a set of piles to be provided to a solid waste processing system. Each pile of the set of piles defines a respective composition for assigning solid waste.

At operation 220B, processing logic obtains, from a sensor, sensor data indicative of a composition of organic material produced by the solid waste processing system. For example, the sensor can be located adjacent to the solid waste processing system. The composition of the organic material can include a nutritional composition. For example, the nutritional composition can include a combination of variables indicative of respective aspects of nutrition. Examples of variables include at least one of protein, fat, fiber, ash, moisture content, etc.

At operation 230B, processing logic causes, based on the sensor data, the batch of organic material to be stored in at least one hopper of a set of hoppers. Each hopper of the set of hoppers is associated with a set of hopper data defining a respective composition of organic material within the hopper. Further details regarding operations 210B-230B are described above with reference to FIGS. 1-2A.

FIG. 2C is a flowchart of an example method 200C for implementing a blend creation and storage stage of a process for converting solid waste into a blend having a target composition, in accordance with some implementations. In some implementations, method 200C can be performed after the completion of method 200B of FIG. 2B.

At operation 210C, processing logic causes organic material to be provided to a mixer to create a blend. In some implementations, causing the organic material to be provided to the mixer includes transporting the organic material from at least one hopper of a set of hoppers. Each hopper of the set of hoppers is associated with a set of hopper data defining a respective composition of organic material within the hopper.

At operation 220C, processing logic obtains, from a sensor, sensor data indicative of an actual composition of the blend. For example, the sensor can be located adjacent to the mixer (e.g., above the mixer).

In some implementations, processing logic can cause one or more supplements to be used to aid in the creation of the blend. For example, the one or more supplements can be used in order to meet target consumer or operational requirements if the actual composition is straying from the target composition. One example of a supplement are wheat midds. Supplements can be added up until they reach a target amount within the total blend (e.g., 25%). The target amount within the total blend can be adjustable. Thus, supplements can increase throughput rate and reduce energy consumption.

At operation 230C, processing logic determines whether the actual composition of the blend satisfies a threshold condition. More specifically, the threshold condition can be defined with respect to a target composition of the blend. For example, determining whether the actual composition of the blend satisfies a threshold condition can include determining whether the actual composition of the blend is within an acceptable range of the target composition.

At operation 240C, processing logic causes the blend to be provided to a drying system for drying. For example, causing the blend to be provided to the drying system can include causing the blend to be transported from the mixer to the drying system.

At operation 250C, processing logic determines that the blend is sufficiently dry for storage. More specifically, the drying system can dry the blend until the blend is sufficiently dry for storage. In some implementations, the drying system can dry the blend to remove enough moisture such that a moisture condition of the blend satisfies a threshold moisture condition suitable for storing the blend for a sufficiently long period of time. For example, the threshold moisture condition can be a moisture of less than or equal to a threshold amount of moisture. The drying process can end upon determining that the moisture condition of the blend satisfies the threshold moisture condition. In some implementations, processing logic can cause organic material stored in a supplemental hopper to be used to lower the moisture content the blend within the mixer.

At operation 260C, after determining that the blend is sufficiently dry for storage (e.g., responsive to or sometime after), processing logic causes the blend to be provided to a cooling system for cooling. For example, causing the blend to be provided to the cooling system can include causing the blend to be transported from the drying system to the cooling system.

At operation 270C, processing logic determines that the blend is sufficiently cool for storage. More specifically, the cooling system can cool the blend until the blend is sufficiently cool for storage. In some implementations, the cooling system can cool the blend to such that a temperature of the blend satisfies a threshold temperature condition suitable for storing the blend. For example, the threshold temperature condition can be a temperature of less than or equal to a threshold temperature. The cooling process can end upon determining that the temperature of the blend satisfies the threshold temperature condition.

At operation 280C, processing logic causes the blend to be stored in at least one container. For example, causing the blend to be provided to be stored in the at least one container can include causing the blend to be transported from the cooling system to the at least one container. In some implementations, the at least one container includes a silo. In some implementations, the at least one container includes a supplemental hopper. Further details regarding operations 210C-280C are described above with reference to FIGS. 1-2B.

At least some the operations of methods 200A-200C can be performed based on a set of constraints. The set of constraints can define parameters that can be used to create a blend having a target composition that is optimized for resource consumption. In some implementations, at least one processing device uses at least one model to determine, from input data include a set of constraints, a target composition for a blend that is optimized for resource consumption. More specifically, the model can be trained to achieve a blend having a target composition with optimized resource consumption, based on a set of constraints (e.g., energy, throughput, nutrients). As more data is acquired, the model will be better informed, resulting in improvements to outputs of the model. In some implementations, the model is a mathematical programming model. For example, the model can be a linear programming model. Mathematical programming can be performed using any suitable method. In some implementations, linear programming is performed using a basis exchange method (e.g., simplex method or criss-cross method). In some implementations, linear programming is performed using an interior point method (e.g., ellipsoid method or projective method). In some implementations, optimizing resource consumption includes optimizing energy consumption. For example, processing logic can optimize drying of the blend using the drying system to minimize energy consumption while achieving the target composition (e.g., target moisture). Illustratively, certain nutritional compositions may go through the drying system better than others (e.g., achieve a higher throughput per hour). Also, organic material that has too high of a fat content can pose a safety hazard due to increased risk of fire. In some implementations, processing logic optimizes resource consumption based on an expected schedule of inputs from the solid waste source(s). This can include at least one expected pile that raw solid waste should be stored in, at least one expected hopper that a batch of organic material should be stored in, and an expected ratio of organic material from one or more hoppers that is transported into the mixer.

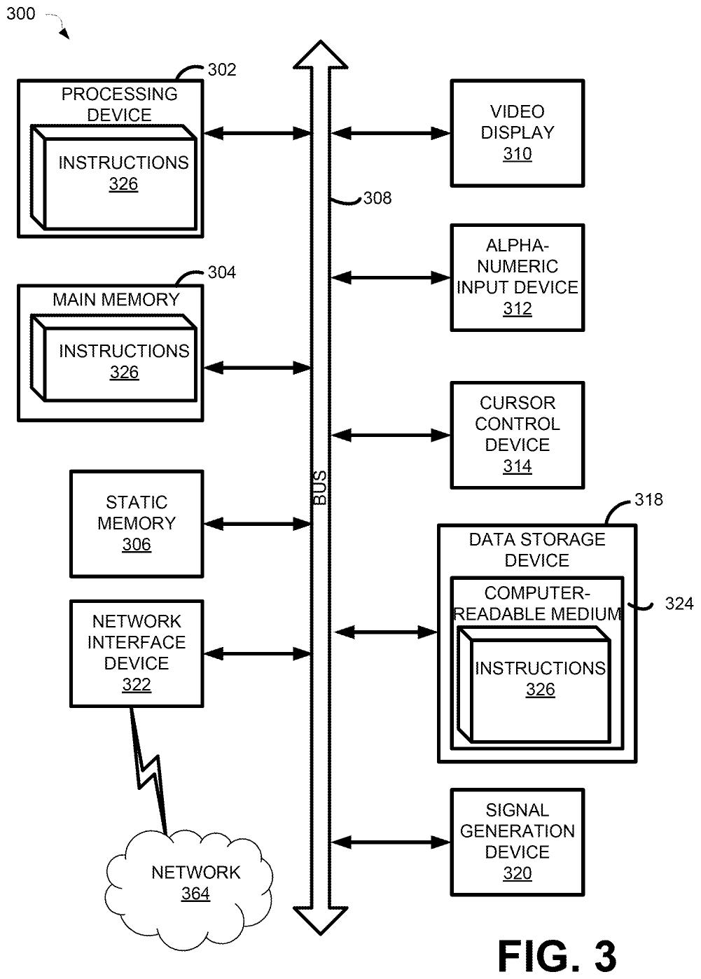

FIG. 3 depicts a block diagram of a computer system 300 operating in accordance with one or more aspects of the disclosure. In various illustrative examples, computer system 300 may correspond to one or more components of system 100 of FIG. 1 (e.g., at least one processing device 190 and/or user device 195). Computer system 300 may be included within a data center that supports virtualization. Virtualization within a data center can result in a physical system being virtualized using virtual machines to consolidate the data center infrastructure and increase operational efficiencies. A virtual machine (VM) may be a program-based emulation of computer hardware. For example, the VM may operate based on computer architecture and functions of computer hardware resources associated with hard disks or other such memory. The VM may emulate a physical computing environment, but requests for a hard disk or memory may be managed by a virtualization layer of a computing device to translate these requests to the underlying physical computing hardware resources. This type of virtualization results in multiple VMs sharing physical resources.

In certain implementations, computer system 300 may be connected (e.g., via a network 364, such as a Local Area Network (LAN), an intranet, an extranet, or the Internet) to other computer systems. Computer system 300 may operate in the capacity of a server or a client computer in a client-server environment, or as a peer computer in a peer-to-peer or distributed network environment. Computer system 300 may be provided by a personal computer (PC), a tablet PC, a set-top box (STB), a Personal Digital Assistant (PDA), a cellular telephone, a web appliance, a server, a network router, switch or bridge, or any device capable of executing a set of executable instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 300 may include a processing device 302, a volatile memory 304 (e.g., random access memory (RAM)), a non-volatile memory 306 (e.g., read-only memory (ROM) or electrically-erasable programmable ROM (EEPROM)), and a data storage device 316, which may communicate with each other via a 308.

Processing device 302 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 300 may further include a network interface device 322. Computer system 300 also may include a video display unit 310 (e.g., an LCD), an alphanumeric input device 312 (e.g., a keyboard), a cursor control device 314 (e.g., a mouse), and a signal generation device 320. Data storage device 316 may include a non-transitory computer-readable storage medium 324 on which may store instructions 326 encoding any one or more of the methods or functions described herein. Instructions 326 may also reside, completely or partially, within volatile memory 304 and/or within processing device 302 during execution thereof by computer system 300, hence, volatile memory 304 and processing device 302 may also constitute machine-readable storage media.

While computer-readable storage medium 324 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of executable instructions for execution by a computer that causes the computer to perform any one or more of the methods described herein. The term “computer-readable storage medium” shall include, but not be limited to, solid-state memories, optical media, and magnetic media.

Other computer system designs and configurations may also be suitable to implement the system and methods described herein. The following examples illustrate various implementations in accordance with one or more aspects of the present disclosure.

Although the operations of the methods herein are shown and described in a particular order, the order of the operations of each method may be altered so that certain operations may be performed in an inverse order or so that certain operations may be performed, at least in part, concurrently with other operations. In certain implementations, instructions or sub-operations of distinct operations may be in an intermittent and/or alternating manner. In certain implementations, not all operations or sub-operations of the methods herein are required to be performed.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that aspects of the present disclosure may be practiced without these specific details. In some instances, well-known structures and devices are shown in block diagram form, rather than in detail, in order to avoid obscuring the present disclosure.

Unless specifically stated otherwise, as apparent from the following discussion, it is appreciated that throughout the description, discussions utilizing terms such as “obtaining,” “receiving,” “causing,” “executing,” “sending,” “initiating,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the specific purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Aspects of the disclosure presented herein are not inherently related to any particular computer or other apparatus. Various general purpose systems may be used with programs in accordance with the teachings herein, or it may prove convenient to construct more specialized apparatus to perform the specified method steps. The structure for a variety of these systems will appear as set forth in the description below. In addition, aspects of the present disclosure are not described with reference to any particular programming language. It will be appreciated that a variety of programming languages may be used to implement the teachings of the disclosure as described herein.

Aspects of the present disclosure may be provided as a computer program product that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not have an ordinal meaning according to their numerical designation.

What is claimed is:

1. A method, comprising:
causing, by at least one processing device, organic material from at least one hopper of a set of hoppers to be provided to a mixer to create a blend, wherein each hopper of the set of hoppers is to store a respective composition of organic material;
obtaining, by the at least one processing device from a sensor, sensor data indicative of an actual composition of the blend;
determining, by the at least one processing device based on the sensor data, whether the actual composition of the blend satisfies a threshold condition with respect to a target composition of the blend; and
in response to determining that the actual composition of the blend satisfies the threshold condition, causing, by the at least one processing device, the blend to be provided to a drying system for drying.

2. The method of claim 1, wherein the composition of the organic material and the composition of the blend each comprises a respective nutritional composition.

3. The method of claim 2, wherein each nutritional composition comprises a combination of variables selected from the group consisting of: protein, fat, fiber, ash, moisture content, or combinations thereof.

4. The method of claim 1, further comprising:
determining, by the at least one processing device, that the blend is sufficiently dry for storage;
after determining that the blend is sufficiently dry, causing, by the at least one processing device, the blend to be provided to a cooling system for cooling;
determining, by the at least one processing device, that the blend is sufficiently cool; and
after determining that the blend is sufficiently cool, causing, by the at least one processing device, the blend to be stored in at least one container.

5. The method of claim 4, wherein the at least one container comprises at least one of: a silo or a supplemental hopper of the set of hoppers.

6. The method of claim 1, further comprising:
obtaining, by the at least one processing device from a second sensor, second sensor data indicative of a composition of a collection of solid waste; and
causing, by the at least one processing device based on the second sensor data, solid waste from the collection of solid waste to be placed within at least one pile of a set of piles, wherein each pile of the set of piles defines a respective composition for assigning solid waste.

7. The method of claim 6, further comprising:
causing, by the at least one processing device, a set of solid waste selected from the at least one pile to be provided to a solid waste processing system;
obtaining, by the at least one processing device from a third sensor, third sensor data indicative of a composition of a batch of organic material produced by the solid waste processing system; and
causing, by the at least one processing device based on the third sensor data, the batch of organic material to be stored in at least one hopper of the set of hoppers.

8. A system comprising:
a memory; and
at least one processing device, operatively coupled to the memory, to perform operations comprising:
causing organic material from at least one hopper of a set of hoppers to be provided to a mixer to create a blend, wherein each hopper of the set of hoppers is to store a respective composition of organic material;
obtaining, from a sensor, sensor data indicative of an actual composition of the blend;
determining, based on the sensor data, whether the actual composition of the blend satisfies a threshold condition with respect to a target composition of the blend; and
in response to determining that the actual composition of the blend satisfies the threshold condition, causing the blend to be provided to a drying system for drying.

9. The system of claim 8, wherein the composition of the organic material and the composition of the blend each comprises a respective nutritional composition.

10. The system of claim 9, wherein each nutritional composition comprises a combination of variables selected from the group consisting of: protein, fat, fiber, ash, moisture content, or combinations thereof.

11. The system of claim 8, wherein the operations further comprise:
determining that the blend is sufficiently dry for storage;
after determining that the blend is sufficiently dry, causing the blend to be provided to a cooling system for cooling;
determining that the blend is sufficiently cool; and
after determining that the blend is sufficiently cool, causing the blend to be stored in at least one container.

12. The system of claim 11, wherein the at least one container comprises at least one of: a silo or a supplemental hopper of the set of hoppers.

13. The system of claim 8, wherein the operations further comprise:
obtaining, from a second sensor, second sensor data indicative of a composition of a collection of solid waste; and
causing, based on the second sensor data, solid waste from the collection of solid waste to be placed within at least one pile of a set of piles, wherein each pile of the set of piles defines a respective composition for assigning solid waste.

14. The system of claim 13, wherein the operations further comprise:
causing a set of solid waste selected from the at least one pile to be provided to a solid waste processing system;
obtaining, from a third sensor, third sensor data indicative of a composition of a batch of organic material produced by the solid waste processing system; and
causing, based on the third sensor data, the batch of organic material to be stored in at least one hopper of the set of hoppers.

15. A system comprising:
a set of hoppers, wherein each hopper of the set of hoppers is to store a respective composition of organic material;
a mixer;
a sensor adjacent to the mixer;
a drying system; and
at least one processing device, operatively coupled to a memory, to:
cause at least one batch of organic material to be transported from the set of hoppers to the mixer to create a blend;
obtain, from the sensor, sensor data indicative of an actual composition of the blend;
determine, based on the sensor data, whether the actual composition of the blend satisfies a threshold condition with respect to a target composition of the blend; and
in response to determining that the actual composition of the blend satisfies the threshold condition, cause the blend to be provided to the drying system for drying.

16. The system of claim 15, wherein the composition of the organic material and the composition of the blend each comprises a respective nutritional composition.

17. The system of claim 15, further comprising:
a cooling system; and
at least one container;
wherein the at least one processing device is further to:
determine that the blend is sufficiently dry for storage:
after determining that the blend is sufficiently dry, cause the blend to be provided to the cooling system for cooling;
determine that the blend is sufficiently cool; and
after determining that the blend is sufficiently cool, cause the blend to be stored in the at least one container.

18. The system of claim 17, wherein the at least one container comprises at least one of: a silo or a supplemental hopper of the set of hoppers.

19. The system of claim 15, further comprising:
a second sensor to obtain second sensor data indicative of a composition of a collection of solid waste;
wherein the at least one processing device is further to cause, based on the second sensor data, solid waste from the collection of solid waste to be placed within at least one pile of a set of piles; and
wherein each pile of the set of piles defines a respective composition for assigning solid waste.

20. The system of claim 19, further comprising:
a solid waste processing system; and
a third sensor adjacent to the solid waste processing system;
wherein the at least one processing device is further to:
cause a set of solid waste selected from the at least one pile to be transported from the at least one pile to the solid waste processing system;
obtain, from the third sensor, third sensor data indicative of a composition of a batch of organic material produced by the solid waste processing system; and
cause, based on the third sensor data, the batch of organic material to be stored in at least one hopper of the set of hoppers.
